(19) United States
(12) Patent Application Publication
(10) Pub. No.: US 2017/0131702 A1
(43) Pub. Date: May 11, 2017

(54) AUTOMATIC POSITION ADJUSTMENT SYSTEM

(71) Applicant: FANUC CORPORATION, Yamanashi (JP)

(72) Inventor: Tomoya ITOU, Yamanashi (JP)

(21) Appl. No.: 15/346,685

(22) Filed: Nov. 8, 2016

(30) Foreign Application Priority Data
Nov. 11, 2015 (JP) 2015-220933

(51) Int. Cl. G05B 19/402

(52) U.S. Cl. CPC G05B 19/402; G05B 2219/36491; G05B 2219/50049

(57) ABSTRACT

An automatic position adjustment system of the present disclosure includes a position detection unit configured to measure the position of an installation target object installed on a table as viewed from a reference position as a reference installation point, a control device configured to calculate a displacement between the position of the installation target object obtained by the position detection unit and viewed from the reference position and a proper target position in installation of the installation target object as viewed from the reference position, and a position adjustment unit configured to correct the position of the installation target object to the target position based on the calculated displacement.

### BACKGROUND OF THE INVENTION

1. Field of the Invention

The present disclosure relates to an automatic position adjustment system for an installation target object.

2. Description of the Related Art

When an installation target object as a target to be machined is installed in a machine tool, such installation is manually performed in a typical case. A robot or an automatic delivery device is sometimes used for installation in the case where it is difficult to manually install a large work as an installation target object or for the purpose of automation of operation. A positioning component such as a striking component or a positioning pin is typically used as a positioning method in installation of the installation target object (see, e.g., Japanese Utility Model Publication No. 56-049686).

With the positioning component, a certain level of installation accuracy can be ensured, but there is a variation in the accuracy due to individual differences such as the material shape and dimensions of the installation target object. For this reason, it is difficult to reduce an installation error to exactly zero. However, in the case of requiring high-accuracy machining, installation needs to be performed with high accuracy. In this case, it is required to manually measure the positional accuracy of the installation target object and to manually correct the installation error.

In the case where other object than a workpiece, such as an additional axial rotation table, is mounted on the machine tool with high accuracy, the direction of the axis of the installation target object having the central axis of rotation, i.e., the additional axial rotation table, needs to be measured. For this reason, it is difficult to ensure accuracy in installation using the positioning component.

As described above, under the situation where the target object needs to be installed with high accuracy or the positioning component cannot ensure accuracy, all steps from installation of the installation target object to position adjustment cannot be automatized.

### SUMMARY OF THE INVENTION

The present disclosure is intended to provide an automatic position adjustment system capable of automatically adjusting an installation position of an installation target object installed on a table.

The present disclosure relates to an automatic position adjustment system including a machining tool, an installation target object installed on a table of the machining tool, a position detection unit configured to detect a displacement from a target position, and a position adjustment unit configured to correct the displacement. Such a system automatically measures the position of the installed installation target object to adjust, based on a measurement result, the position of the installation target object to a proper target position in installation.

The automatic position adjustment system of the present disclosure is an automatic position adjustment system including a machining tool having a table and configured to adjust the position of an installation target object installed on the table. Such a system includes a position detection unit configured to measure the position of the installation target object installed on the table as viewed from a reference position as a reference installation point, a displacement calculation unit configured to calculate a displacement between the position of the installation target object obtained by the position detection unit and viewed from the reference position and a proper target position in installation of the installation target object as viewed from the reference position, and a position adjustment unit configured to correct the position of the installation target object to the target position based on the displacement calculated by the displacement calculation unit.

A contact stylus device, a non-contact distance measurement device, or an imaging device may be used as the position detection unit.

The position adjustment unit grasps and moves the installation target object to correct the displacement with respect to the target position.

The position adjustment unit moves, by pushing or pulling, the installation target object to correct the displacement with respect to the target position.

The position adjustment unit moves, in the state in which part of the installation target object is supported, the table to correct the displacement with respect to the target position.

The position adjustment unit repeatedly adjusts the position of the installation target object until the displacement with respect to the target position is within an acceptable value.

The automatic position adjustment system further includes an automatic delivery unit configured to supply the installation target object onto the table of the machining tool.

A robot or a loader may be used as the position adjustment unit.

A robot or a loader may be used as the automatic delivery unit.

The position adjustment unit and the automatic delivery unit are formed of a single robot or a single loader.

The automatic position adjustment system further includes a robot or a screwing device configured to fix the installation target object onto the table of the machining tool after adjustment of the position of the installation target object by the position adjustment unit.

According to the present disclosure, the installation position of the installation target object installed on the table of the machining tool can be automatically adjusted, leading to labor-saving in operation accompanied by machining.

### BRIEF DESCRIPTION OF THE DRAWINGS

The above-described purposes and features and other purposes and features of the present disclosure will be apparent from the following description of an embodiment with reference to attached drawings. These drawings are as follows:

FIG. 1 is a schematic configuration diagram of an automatic position adjustment system of an embodiment of the present disclosure;

FIG. 2 illustrates an example where a contact stylus device is used as a position detection unit in the automatic position adjustment system of FIG. 1;

FIG. 3 illustrates an example where an imaging unit is used as the position detection unit in the automatic position adjustment system of FIG. 1;

FIG. 4 illustrates an example of position adjustment operation when a robot including a grasping unit is used as a position adjustment unit in the automatic position adjustment system of FIG. 1;

FIG. 5 illustrates an example (1) of the position adjustment operation when a robot including a push pole is used as the position adjustment unit in the automatic position adjustment system of FIG. 1;

FIG. 6 illustrates an example (2) of the position adjustment operation when the robot including the push pole is used as the position adjustment unit in the automatic position adjustment system of FIG. 1;

FIG. 7 is a flowchart of operation of the automatic position adjustment system of the embodiment of the present disclosure;

FIG. 8 is a view of an example where a robot is used as an automatic delivery unit in the automatic position adjustment system of the embodiment of the present disclosure; and

FIG. 9 is a view of an example where the robot is used as the position adjustment unit in the automatic position adjustment system of the embodiment of the present disclosure.

### DETAILED DESCRIPTION OF THE PREFERRED EMBODIMENT

An embodiment of the present disclosure will be described below with reference to drawings. Note that in description below, the same reference numerals as those of a typical technique will be used to represent identical or similar elements.

FIG. 1 is a schematic configuration diagram of an automatic position adjustment system of the embodiment of the present disclosure. An automatic position adjustment system 1 of the present embodiment includes a machining tool 2 including a table 23 on which an installation target object 21 such as a work and an additional axial rotation table is installed, a position detection unit 3 configured to detect a position at which the installation target object 21 is installed, a position adjustment unit 4 configured to correct the installation position of the installation target object 21 to a target position as a proper position in installation of the installation target object 21, and a control device 5 configured to control the machining tool 2, the position detection unit 3, and the position adjustment unit 4.

The machining tool 2 may be a machine for installing a work as the installation target object 21 on the table 23 to process the work, or a machine for installing a machining assisting device, such as the additional axial rotation table, as the installation target object 21 on the table 23 to use the device for machining.

The installation target object 21 needs to be installed at the target position on the table 23 before machining operation is performed by the machining tool 2. Note that the “position” at which the installation target object 21 is installed includes, in the present disclosure, a two-dimensional or three-dimensional “coordinate position” at which the installation target object 21 is installed, and an “attitude” determined by, e.g., the direction of the installation target object 21.

The position detection unit 3 is a functional unit configured to detect the position of the installation target object 21 installed on the table 23, and is configured to detect the position of the installation target object 21 as viewed from a reference position. The position of the installation target object 21 detected by the position detection unit 3 is detected based on coordinate positions for at least one or more points of interest on the installation target object 21. The points of interest on the installation target object 21 may be optionally determined according to the shape and type of the installation target object 21. For example, when the installation target object 21 is in a substantially cylindrical shape, the position of the center of gravity when the cylindrical shape is viewed from above may be taken as a point of interest. When the installation target object 21 is in a substantially rectangular parallelepiped shape, any two of corners may be taken as points of interest. Alternatively, a mark may be additionally provided on the installation target object 21, and may be taken as a point of interest. When the position of the installation target object 21 is adjusted in a two-dimensional plane on the table 23, the coordinate positions may be often measured for at least two points of interest.

For example, a contact stylus device, a non-contact distance measurement device, or an imaging device may be used as the position detection unit 3.

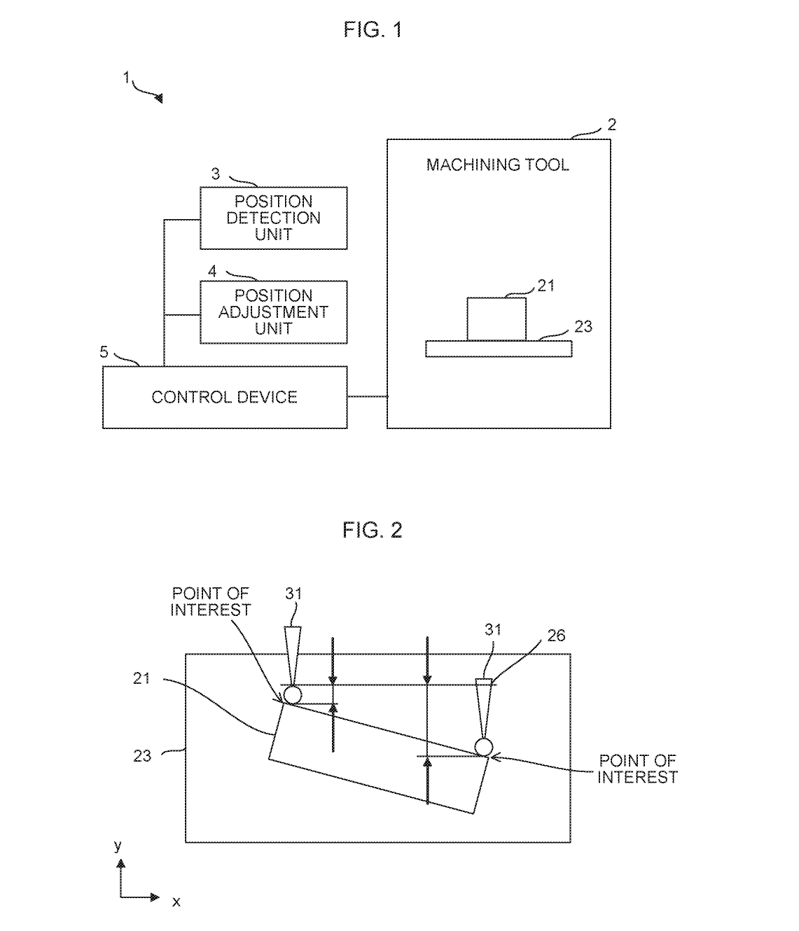

FIG. 2 illustrates an example of position detection when the contact stylus device is used as the position detection unit 3. A contact stylus device 31 is capable of detecting both end positions of the installation target object 21 as viewed from a reference plane 26 set as the reference position in advance. In the example illustrated in FIG. 2, upper right and left end portions of the installation target object 21 are taken as points of interest to measure the distance from the reference plane 26 to each point of interest. In this manner, the current installation position (the two-dimensional coordinate position and attitude) of the installation target object 21 can be detected.

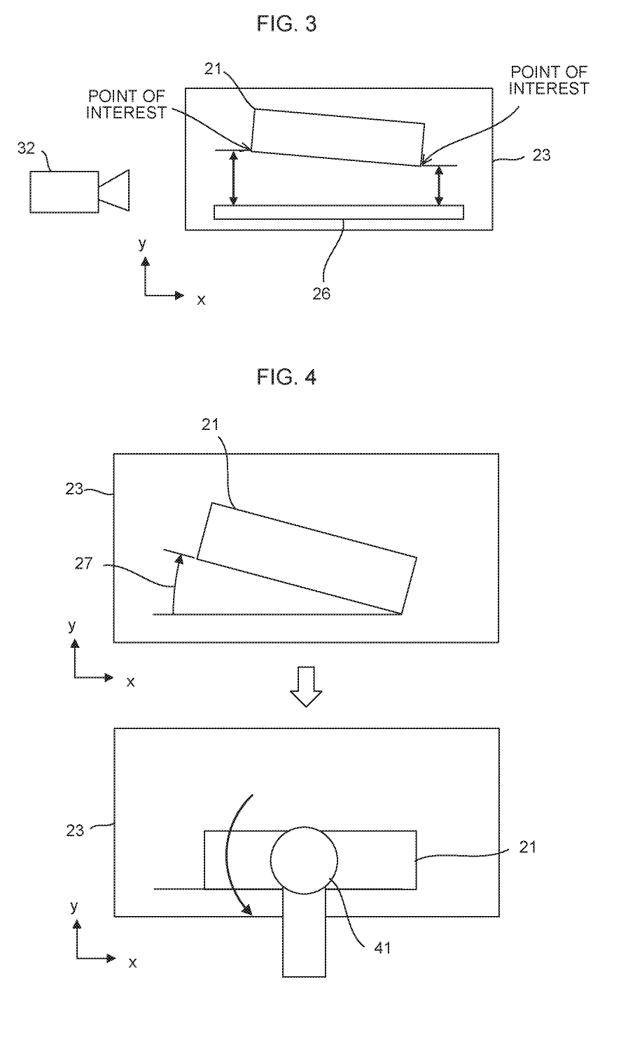

FIG. 3 illustrates an example of position detection when the imaging device is used as the position detection unit 3. An imaging device 32 is capable of simultaneously imaging the reference plane 26 marked as the reference position on the table 23 and the installation target object 21, and analyzing the acquired image to detect the position of each portion of the installation target object 21. In the example illustrated in FIG. 3, the image acquired by simultaneous imaging of the installation target object 21 and the reference plane 26 is analyzed, and lower right and left end portions of the installation target object 21 are taken as points of interest to calculate the distance from the reference plane 26 to each point of interest. In this manner, the current installation position (the two-dimensional coordinate position and attitude) of the installation target object 21 can be detected.

The reference position (the above-described reference plane 26) used by the position detection unit 3 may be optionally determined according to a detection device to be used as the position detection unit 3, and the position to be taken as the reference position may be determined in terms of design. For example, in the case of using the contact stylus device as the position detection unit 3, a predetermined coordinate position of the contact stylus device may be taken as the reference position. In the case of using the imaging device 32 as the position detection unit 3, an end portion of the table 23 or other imageable portions on the table may be taken as the reference position instead of marking the reference plane 26 on the table 23.

The position adjustment unit 4 is a functional unit configured to correct the position of the installation target object 21 installed on the table 23 to the target position, and is configured to move the installation target object 21 on the table 23 to correct the position of the installation target object 21. For example, a robot including an arm, a robot grasping a push pole, a hook member, etc. at an arm tip end, or a loader may be used as the position adjustment unit 4.

The control device 5 controls the machining tool 2, the position detection unit 3, and the position adjustment unit 4 to correct the position of the installation target object 21 installed on the table 23 to the target position. A control device used for control of machining of the machining tool 2 or a robot control device controlling a robot, etc. may be used as the control device 5. Alternatively, other devices such as a computer may be used as the control device 5.

The proper target position in installation of the installation target object 21 is stored in advance in a not-shown memory of the control device 5 by, e.g., operation of an operator or a program. The control device 5 calculates the displacement of the current installation position with respect to the target position of the installation target object 21 based on the position of the installation target object 21 detected by control of the position detection unit 3 and the proper target position, which is stored in the memory, in installation of the installation target object 21. The displacement of the current installation position with respect to the target position of the installation target object 21 can be, for at least one or more points of interest on the installation target object 21, defined according to a straight vector value, a rotation vector value, a distance for each coordinate axis, etc. in the case where the installation target object 21 is at the current installation position and the case where the installation target object 21 is at the proper target position in installation.

For example, in the example illustrated in FIG. 3, when the target position of the installation target object 21 is such a position that the lower side of the installation target object 21 illustrated on the upper side in the figure contacts the reference plane 26, the Y-axis direction displacement of the current installation position with respect to the target position of the installation target object 21 can be defined according to the distance in a Y-axis direction between the point of interest at the lower left end portion of the installation target object 21 and the reference plane 26 and the distance in the Y-axis direction between the point of interest at the lower right end portion of the installation target object 21 and the reference plane 26.

As a result of calculation of the displacement of the current installation position with respect to the target position of the installation target object 21, when the calculated displacement exceeds an acceptable value set in advance in the not-shown memory, the control device 5 controls the position adjustment unit 4 to move the position of the installation target object 21 installed on the table 23 in the direction in which the calculated displacement decreases.

FIG. 4 (an upper view) and FIG. 4 (a lower view) illustrate an example of position adjustment of the installation target object when a robot 41 including an arm capable of grasping the installation target object is used as the position adjustment unit 4. The control device 5 controls the robot 41 to rotatably move the installation target object 21 such that the displacement 27 (FIG. 4 (the upper view)) of the point of interest at the lower left end portion of the installation target object 21 decreases, the displacement 27 being detected by the position detection unit 3. In this manner, the position of the installation target object 21 is corrected.

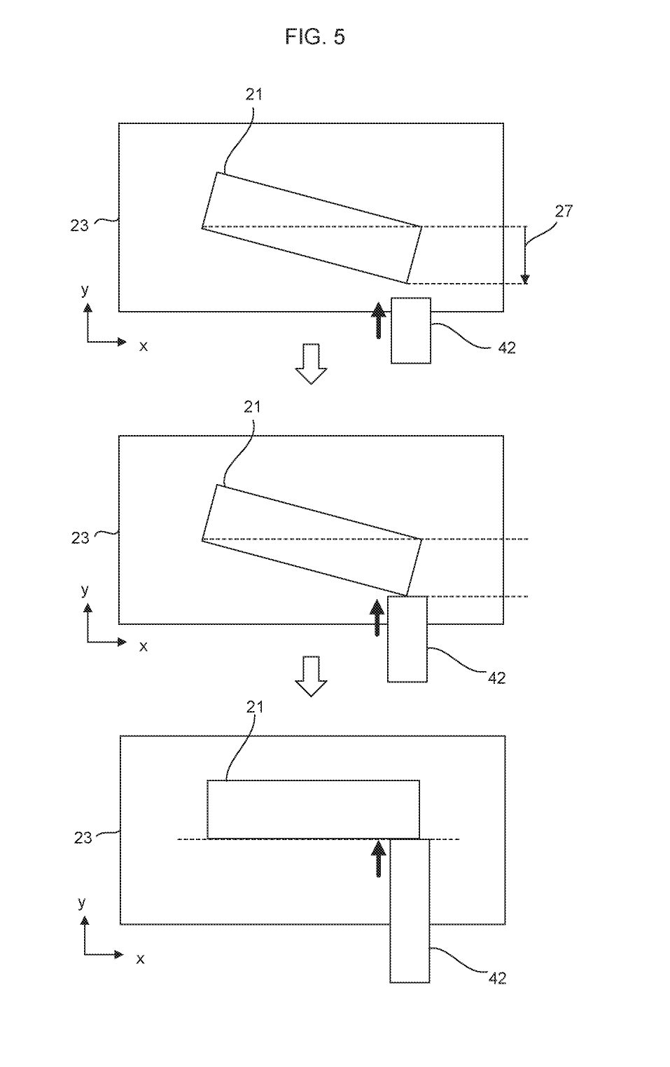

FIG. 5 (an upper view to a lower view) illustrate an example of position adjustment of the installation target object when a robot 42 capable of grasping a push pole to push and move the installation target object 21 is used as the position adjustment unit 4. The control device 5 controls the robot 42 to push and move the point of interest at the lower right end portion of the installation target object 21 (FIG. 5 (a middle view)) such that the displacement 27 (FIG. 5 (the upper view)) of the point of interest at the lower right end portion of the installation target object 21 decreases, the displacement 27 being detected by the position detection unit. In this manner, the position of the installation target object 21 is corrected (FIG. 5 (the lower view)). Note that when a robot grasping a hook member is used, the lower right end portion of the installation target object 21 is hooked and pulled upward as viewed in the figures, and in this manner, the position can be corrected.

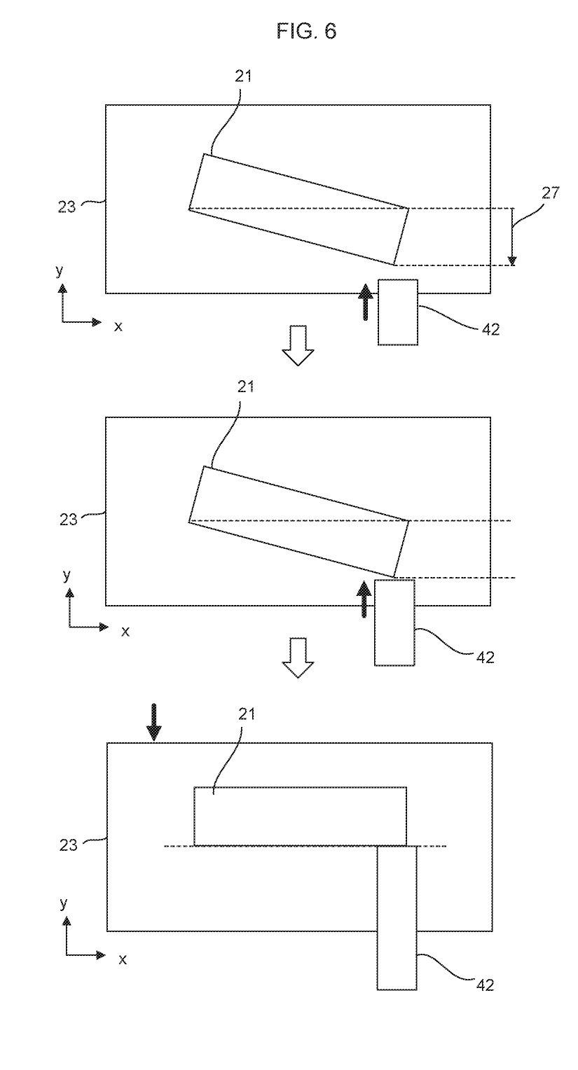

FIG. 6 (an upper view to a lower view) illustrate another example of position adjustment of the installation target object by using, as the position adjustment unit 4, the robot 42 capable of grasping the push pole to support the installation target object 21. The control device 5 controls the robot 42 to move, in the state (FIG. 6 (a middle view)) in which the point of interest at the lower right end portion of the installation target object is supported, the table 23 downward as viewed in the figures such that the displacement 27 (FIG. 6 (the upper view)) of the point of interest at the lower right end portion of the installation target object 21 decreases, the displacement 27 being detected by the position detection unit 3. In this manner, the position of the installation target object 21 is corrected (FIG. 6 (the lower view)).

In the example illustrated in FIG. 4 (the upper view and the lower view), the installation target object 21 can be moved at once to the position at which the displacement of each point of interest is smaller. On the other hand, in the examples illustrated in FIG. 5 (the upper view to the lower view) and FIG. 6 (the upper view to the lower view), a series of operation of controlling the position adjustment unit 4 to move one of the points of interest showing the greatest displacement with respect to the target position to decrease the displacement of such a point of interest, controlling the position detection unit 3 again to detect the position of the installation target object 21 to calculate the displacement of each point of interest, and controlling the position adjustment unit 4 to move the point of interest showing the greatest displacement with respect to the target position may be repeated, for example.

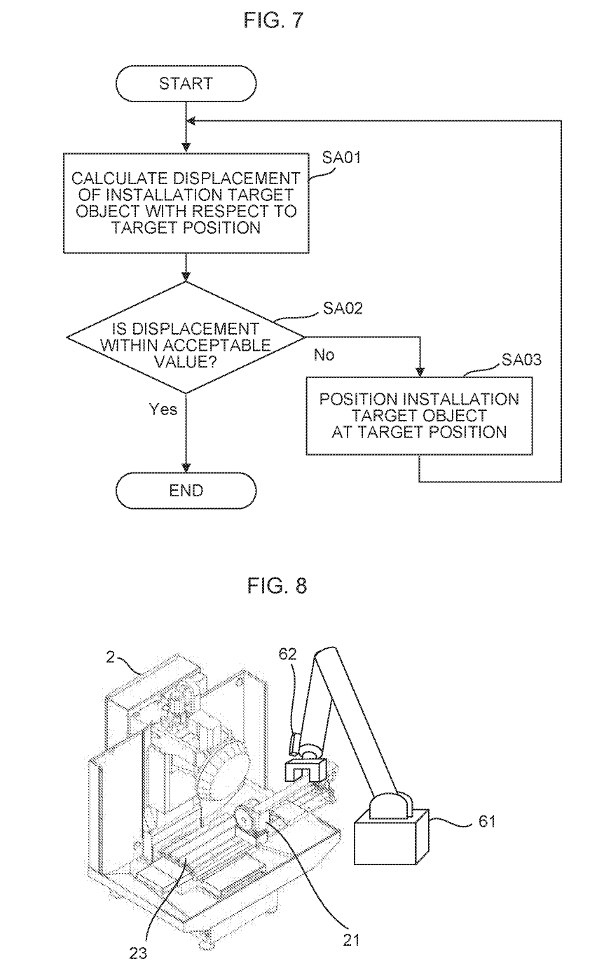

Operation of the automatic position adjustment system 1 of the present embodiment will be described below with reference to a flowchart of FIG. 7.

[Step SA01] The control device 5 controls the position detection unit 3 to detect the current installation position of the installation target object 21 to calculate the displacement between the detected current installation position and the preset target position.

[Step SA02] The control device 5 determines whether or not the displacement calculated at step SA01 is within the preset acceptable value. When the displacement is within the preset acceptable value, the machining is terminated. When the displacement exceeds the preset acceptable value, the machining proceeds to step SA03.

[Step SA03] The control device 5 controls the position adjustment unit 4 to move the installation target object 21 in the direction in which the displacement calculated at step SA01 decreases. After movement has been completed, the machining returns to step SA01.

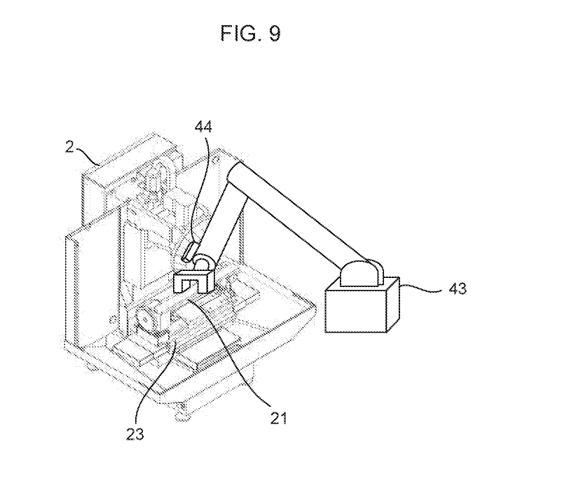

FIG. 8 illustrates an example where a robot 61 is used as an automatic delivery device 6 configured to install the installation target object 21 on the table 23 of the machining tool 2. Moreover, FIG. 9 illustrates an example where a robot 43 is used as the position adjustment unit 4 configured to adjust the position of the installation target object 21 installed on the table 23. When the robot 43 is used as the position adjustment unit 4 as described above, an imaging unit 44 provided at the robot 43 can be used as the position detection unit 3. The function of the automatic delivery device 6 illustrated in FIG. 8 and the function of the position adjustment unit 4 illustrated in FIG. 9 can be provided by a single robot.

Further, an electric screwdriver may be attached to an arm of the robot illustrated in FIG. 8 or 9, or a dedicated screwing device may be separately prepared so that the installation target object 21 can be screwed and fixed onto the table 23 of the machining tool 2 after adjustment of the position of the installation target object 21 by the position adjustment unit 4.

The embodiment of the present disclosure has been described above, but the present disclosure is not limited to the above-described examples of the embodiment. Change can be optionally made to implement various aspects.

1. An automatic position adjustment system including a machining tool having a table and configured to adjust a position of an installation target object installed on the table, comprising:
a position detection unit configured to measure the position of the installation target object installed on the table as viewed from a reference position as a reference installation point;
a displacement calculation unit configured to calculate a displacement between the position of the installation target object obtained by the position detection unit and viewed from the reference position and a proper target position in installation of the installation target object as viewed from the reference position; and
a position adjustment unit configured to correct the position of the installation target object to the target position based on the displacement calculated by the displacement calculation unit.

2. The automatic position adjustment system of claim 1, wherein
the position detection unit is a contact stylus device, a non-contact distance measurement device, or an imaging device.

3. The automatic position adjustment system of claim 1, wherein
the position adjustment unit grasps and moves the installation target object to correct the displacement with respect to the target position.

4. The automatic position adjustment system of claim 1, wherein
the position adjustment unit moves, by pushing or pulling, the installation target object to correct the displacement with respect to the target position.

5. The automatic position adjustment system of claim 1, wherein
the position adjustment unit moves, in a state in which part of the installation target object is supported, the table to correct the displacement with respect to the target position.

6. The automatic position adjustment system of claim 1, wherein
the position adjustment unit repeatedly adjusts the position of the installation target object until the displacement with respect to the target position is within an acceptable value.

7. The automatic position adjustment system of claim 1, further comprising:
an automatic delivery unit configured to supply the installation target object onto the table of the machining tool.

8. The automatic position adjustment system of claim 1, wherein
the position adjustment unit is a robot or a loader.

9. The automatic position adjustment system of claim 7, wherein
the automatic delivery unit is a robot or a loader.

10. The automatic position adjustment system of claim 7, wherein
the position adjustment unit and the automatic delivery unit are formed of a single robot or a single loader.

11. The automatic position adjustment system of claim 1, further comprising:
a robot or a screwing device configured to fix the installation target object onto the table of the machining tool after adjustment of the position of the installation target object by the position adjustment unit.
